(19) United States
(12) Patent Application Publication
(10) Pub. No.: US 2017/0035071 A1
(43) Pub. Date: Feb. 9, 2017

(54) Fat and/or Oil Composition for Heat Cooking and Method of Preparing Same, and Method of Preventing Deterioration of Fat and/or Oil for Heat Cooking Caused by Heating

(71) Applicant: The Nisshin OilliO Group, Ltd., Tokyo (JP)

(72) Inventors: Kousuke ABE, Yokohama-shi (JP); Tatsuya FUSHIMI, Yokohama-shi (JP)

(73) Assignee: The Nisshin OilliO Group, Ltd., Tokyo (JP)

(21) Appl. No.: 15/078,144

(22) Filed: Mar. 23, 2016

(30) Foreign Application Priority Data
Aug. 3, 2015 (JP) 2015-153571

(51) Int. Cl. A23D 9/06; A23D 9/013; A23L 5/10

(52) U.S. Cl. CPC A23D 9/06; A23L 5/11; A23D 9/013; A23V 2002/00

(57) ABSTRACT

Provided is a fat and/or oil composition for heat cooking, comprising a fat and/or oil, and an alkali metal soap of a saturated fatty acid having from 4 to 16 carbon numbers, wherein an alkali metal content in the fat and/or oil composition for heat cooking is from 0.1 to 5.0 mass ppm, and a method of preparing the same. Also provided is a method of preventing deterioration of a fat and/or oil for heat cooking caused by heating, comprising the step of adding an alkali metal soap of a saturated fatty acid having from 4 to 16 carbon numbers to the fat and/or oil for heat cooking to produce an alkali metal content in the fat and/or oil composition for heat cooking of from 0.1 to 5.0 mass ppm.

### TECHNICAL FIELD

The Present disclosure relates to a fat and/or oil composition for heat cooking and a method of preparing the same, and a method of preventing deterioration of a fat and/or oil for heat cooking caused by heating.

### BACKGROUND

In recent years, there has been a growing interest in quality of foods, and edible fat(s) and/or oil(s) used in processed foods, such as deep-fried foods, are no exception. Edible fats and/or oils generally undergo deterioration due to heat and light. At this time, the presence of water causes degradation due to hydrolysis, and the presence of oxygen causes deterioration due to oxidization, both of which lead to deterioration in taste and color tone. Especially, fried foods, such as fries, tempura, and karaage, contain a lot of moisture, and when fried foods are heat-cooked by using oil at a temperature of approximately 180° C., it is important to prevent deterioration due to hydrolysis. In supermarkets, eating places, and restaurants, commercially used fats and/or oils for heat cooling are often employed to heat-cook a large volume of fried foods at high temperature for a long period of time, and these fats and/or oils undergo quick deterioration. This results in adverse effects on taste and appearance of the fried foods. These fats and/or oils therefore need to be disposed and replaced within a short period of time. However, since this causes economic and environmental burdens, technique for preventing deterioration in fats and/or oils for heat cocking has been needed.

Acid value is used as a typical index of the degree of deterioration in a fat and/or oil for heat cooking caused by heating, which indirectly indicates the amount of free fatty acid generated by hydrolysis and oxidization of the fat and/or oil. Suppression of an increase in acid value caused by heating has been attempted. For example, Patent Literature 1 discloses suppressing an increase in acid value caused by heating, by adding one or more components selected from sodium and potassium into a fat and/or oil in an amount of 0.1 to 1 μmol/g.

### CITATION LIST

### Patent Literature

PTL 1: Japanese Patent No. 4798310

### SUMMARY

### Technical Problem

Meanwhile, in addition to an increase in acid value, coloring and foaming are also indexs of the degree of deterioration of a fat and/or oil for heat cooking that is caused by heating. Coloring is considered to be associated cooperatively with heating of substances eluted from a cooked object, such as an ingredient to be fried, and with the amount of conjugated diene, carbonyl, hydroxy, and epoxy group that are generated by heating of the fat and/or oil, and coloring might cause coloring of a fried product. Foaming is considered to be caused mainly by polymerized triglycerides generated by heating of the fat and/or oil. Foaming also leads to decrease in workability and safety during frying.

Thus, since the indexs of deterioration, such as an increase in acid value, coloring, and foaming, are directed to different targets for evaluation, there is a need for a way to prevent not a single index but all of an increase in acid value, generation of polymerized triglycerides, and coloring in a balanced manner and to improve workability and safety during fry.

In view of the above, the present disclosure is to provide a fat and/or oil composition for heat cooking that prevents an increase in acid value, generation of polymerized triglycerides, and coloring in a balanced manner and a method of preparing the same, and a method of preventing deterioration of a fat and/or oil for heat cooking caused by heating.

### Solution to Problem

One of aspects of the present disclosure resides in a fat and/or oil composition for heat cooking, comprising a fat and/or oil, and an alkali metal soap of a saturated fatty acid having from 4 to 16 carbon numbers, wherein an alkali metal content in the fat and/or oil composition for heat cooking is from 0.1 to 5.0 mass ppm.

In a preferred embodiment of the fat and/or oil composition for heat cooking according to the present disclosure, the alkali metal soap comprises a sodium soap.

Another aspect of the present disclosure resides in a method of preparing a fat and/or oil composition for heat cooking, the method comprising the steps of refining a fat and/or oil and thereafter adding an alkali metal soap of a saturated fatty acid having from 4 to 16 carbon numbers to the refined fat and/or oil to produce an alkali metal content in the fat and/or oil composition for heat cooking of from 0.1 to 5.0 mass ppm.

In a preferred embodiment of the method of preparing a fat and/or oil composition for heat cooking according to the present disclosure, the alkali metal soap comprises a sodium soap.

Yet another aspect of the present disclosure resides in a method of preventing deterioration of a fat and/or oil for heat cooking caused by heating, the method comprising the step of adding an alkali metal soap of a saturated fatty acid having from 4 to 16 carbon numbers to the fat and/or oil for heat cooking to produce an alkali metal content in the fat and/or oil composition for heat cooking of from 0.1 to 5.0 mass ppm.

In a preferred embodiment of the method of preventing deterioration of a fat and/or oil for heat cooking that is caused by heating according to the present disclosure, the alkali metal soap comprises a sodium soap.

### Advantageous Effects

According to the present disclosure, a fat and/or oil composition for heat cooking that prevents an increase in acid value, generation of polymerized triglycerides, and coloring that are caused by heating, and a method of preparing the same are provided. Furthermore, provided is a method of preventing deterioration of a fat and/or oil for heat cooking caused by heating by which an increase in acid value, generation of polymerized triglycerides, and coloring caused by heating are suppressed in a balanced manner.

The fat and/or oil composition for heat cooking and the method of preparing the same, and the method of preventing deterioration of a fat and/or oil for heat cooking that is caused by heating improve workability and safety during fry.

### DETAILED DESCRIPTION

The present inventors have found that an increase in acid value, generation of polymerized triglycerides, and coloring are suppressed in a balanced manner even under harsh use conditions of high temperature for a long period of time, such as those of a commercially used fat and/or oil employed in fry cooking, by adding, to a fat and/or oil, an alkali metal soap of a saturated fatty acid having from 4 to 16 carbon numbers and by regulating an alkali metal content in the fat and/or oil composition for heat cooking to be from 0.1 to 5.0 mass ppm. Based on the above findings, the present inventors have made a fat and/or oil composition for heat cooking and a method of preparing the same, and a method of preventing deterioration of a fat and/or oil for heat cooking caused by heating according to the present disclosure.

<Fat and/or Oil Composition for Heat Cooking>

In the following, a description is given in detail of a fat and/or oil composition for heat cooking according to the present disclosure, with respect to each of the components.

(Fat and/or Oil)

A fat and/or oil composition for heat cooking according to the present disclosure contains a typical fat and/or oil for heat cooking as a main component. Such a typical fat and/or oil for heat cooking may include an animal and vegetable fats and/or oils, and a hydrogenated fat and/or oil, a fractionated fat and/or oil, and a transesterified fat and/or oil of the animal and vegetable fat and/or oil. These fats and/or oils may be used alone or in a combination. Examples of the animal and vegetable fat and/or oil may include soybean oil, rapeseed oil, high oleic rapeseed oil, sunflower oil, high oleic sunflower oil, olive oil, safflower oil, high oleic safflower oil, corn oil, cotton seed oil, rice bran oil, beef tallow, milk fat, fish oil, coconut oil, palm oil, and palm kernel oil. The fats and/or oils that are in a liquid state at a temperature of 20° C. are preferable, because those solidifying at a room temperature need to be liquefied by heating for use. Material fats and/or oils that are in a solid state at a temperature of 20° C. and that generally turn to a liquid state when used together with another material fat and/or oil may also be preferable. Especially, rapeseed oil, a mixture of rapeseed oil and soybean oil, or the like, which have an advantage of being a liquid oil having a low melting point and excellent oxidative stability, may be preferably used.

The aforementioned typical fat and/or oil for heat cooking preferably constitutes the entire fat and/or oil composition for heat cooking according to the present disclosure, except for a part of the fat and/or oil composition that includes the alkali metal soap of a saturated fatty acid having from 4 to 16 carbon numbers and other additives added as needed.

### (Alkali Metal Soap)

The fat and/or oil composition for heat cooking according to the present disclosure contains the alkali metal soap of a saturated fatty acid having from 4 to 16 carbon numbers. The alkali metal soap is salt containing a saturated fatty acid having from 4 to 16 carbon numbers and an alkali metal.

Examples of the saturated fatty acid having from 4 to 16 carbon numbers included in the alkali metal soap may include but not particularly limited to butyric acid (C4), caproic acid (C6), caprylic acid (C8), capric acid (C10), lauric acid (C12), myristic acid (C14), palmitic acid (C16) and the like. Among these examples, caprylic acid (C8), lauric acid (C12), and palmitic acid (C16) are preferable.

Examples of the alkali metal included in the alkali metal soap may include sodium and potassium, and sodium is preferable.

A commercially available product may be used as the alkali metal soap of a saturated fatty acid having from 4 to 16 carbon numbers. Alternatively, the alkali metal soap of a saturated fatty acid having from 4 to 16 carbon numbers, obtained by mixing a solution of alkali metal hydroxide with a saturated fatty acid having from 4 to 16 carbon numbers or a fat and/or oil containing the saturated fatty acid, saponifying the mixture, and refining the saponified mixture as needed, may also be used.

The content of the alkali metal soap of a saturated fatty acid having from 4 to 16 carbon numbers is adjusted to produce an alkali metal content in the fat and/or oil composition for heat cooking of from 0.1 to 5.0 mass ppm.

### (Alkali Metal Content)

The alkali metal content in the fat and/or oil composition for heat cooking according to the present disclosure is from 0.1 to 5.0 mass ppm. When the alkali metal content in the fat and/or oil composition for heat cooking containing the alkali metal soap of a saturated fatty acid having from 4 to 16 carbon numbers is from 0.1 to 5.0 mass ppm, the advantageous effects of suppressing an increase in acid value, generation of polymerized triglycerides, and coloring are provided in a balanced manner. The alkali metal content in the fat and/or oil composition for heat cooking is preferably from 0.1 to 3.5 mass ppm, more preferably from 0.3 to 3.1 mass ppm, and most preferably from 0.3 to 2.0 mass ppm. The alkali metal content in the above range allows the advantageous effects of suppressing an increase in acid value, generation of polymerized triglycerides, and coloring to be provided in a more balanced manner. The alkali metal content in the fat and/or oil composition for heat cooking may be quantified by atomic absorption spectrophotometry, with the alkali metal soap of a saturated fatty acid having from 4 to 16 carbon numbers being added in the fat and/or oil composition for heat cooking.

### (Other Components)

Other components may also be added to the fat and/or oil composition for heat cooking according to the present disclosure in such amounts that do not affect adversely the advantageous effects of the present disclosure. Such components include those used in typical edible fats and/or oils (such as food additives). Examples of these components may include anti-oxidizing agents, emulsifying agents, silicone oils, crystal regulators, oral sensation improving agents, and coloring components. These components are preferably added sometime after deodorization and before packing.

Examples of the anti-oxidizing agent include tocopherols, ascorbic acids, flavone derivatives, kojic acid, gallic acid derivatives, catechin and esters thereof, fukiic acid, gossypol, sesamol, and terpenes. Examples of the emulsifying agent may include monoglycerides, diglycerides, organic acid monoglycerides, polyglycerol fatty acid esters, sucrose fatty acid esters, sorbitan fatty acid esters, polysorbates, propylene glycol fatty acid esters, polyglycerine condensed ricinoleates, waxes, sterol esters, and phospholipids.

Examples of the silicone oil may include those commercially available for food use and may include but not particularly limited to those having a dimethylpolysiloxane structure and having a kinetic viscosity at 25° C. of 800 to 5000 mm²/s. The kinetic viscosity of the silicone oil is, for example, preferably from 800 to 2000 mm²/s and more preferably from 900 to 1100 mm²/s. The term kinetic viscosity herein refers to a value measured in conformity with JIS K 2283 (2000). The silicone oil may contain microparticulate silica in addition to the silicone oil.

<Method of Preparing Fat and/or Oil Composition for Heat Cooking>

A fat and/or oil used in the method of preparing a fat and/or oil composition for heat cooking according to the present disclosure is prepared by using, as a starting material, a raw fat and/or oil extracted from a plant seed, a fruit, or an animal material, similarly to a typical fat and/or oil. The method of preparing a fat and/or oil composition includes, if necessary, a degumming step, a deoxidization step, and a decolorizing step in the stated order. Then, if necessary, a dewaxing step follows, and after that, a deodorization step and the subsequent refining step are performed. This may complete the preparation of the fat and/or oil composition. The degumming step, the deoxidization step, and the dewaxing step may be appropriately adopted in accordance with the quality of the raw fat and/or oil that may vary according to a fat and/or oil material from which the raw fat and/or oil is extracted.

The preparation method according to the present disclosure comprises, in addition to the refining step as described above, the step of adding the alkali metal soap of a saturated fatty acid having from 4 to 16 carbon numbers to the refined fat and/or oil to produce an alkali metal content in the fat and/or oil composition for heat cooking of from 0.1 to 5.0 mass ppm. In detail, the alkali metal soap of a saturated fatty acid having from 4 to 16 carbon numbers is added to the refined fat and/or oil in an amount that produces an alkali metal content in the fat and/or oil composition for heat cooking of from 0.1 to 5.0 mass ppm. Preferably, the amount of the alkali metal soap of a saturated fatty acid having from 4 to 16 carbon numbers or the amount of the refined fat and/or oil are adjusted to produce the alkali metal content in thus prepared fat and/or oil composition for heat cooking of from 0.1 to 5.0 mass ppm as measured by atomic absorption spectrophotometry.

Any alkali metal soap described above may be used as the alkali metal soap of a saturated fatty acid having from 4 to 16 carbon numbers. Adding the alkali metal soap may comprise adding and dissolving the alkali metal soap to and in the fat and/or oil that has been heated after the refining step. The alkali metal soap may also be dissolved in a small volume of a solvent (e.g., water and refined fat and/or oil) and then mixed with an emulsifying agent, such as organic acid monoglyceride, polyglycerol fatty acid ester, sucrose fatty acid ester, and monoglyceride, as needed, before being added to a large volume of refined fat and/or oil. After addition, the alkali metal soap may be dissolved or dispersed uniformly in the fat and/or oil by stirring, agitating or the like, and subsequently, a dehydration process may be performed if necessary. The dehydration is preferably performed under reduced pressure at approximately from 70° C. to 105° C. Furthermore, the alkali metal may be preferably mixed with an emulsifying agent before being added to the refined fat and/or oil.

The preparation method according to the present disclosure may also comprise the step of adding the aforementioned other additives, as needed. The step of adding the other additives is preferably performed after the fat and/or oil has undergone the refining step, and conditions during the adding step, such as temperature of the fat and/or oil, may be appropriately selected depending on what additives are used and why the additives are added.

<Method of Preventing Deterioration of Fat and/or Oil Composition for Heat Cooking>

The method of preventing deterioration of a fat and/or oil for heat cooking caused by heating according to the present disclosure comprises the step of adding the alkali metal soap of a saturated fatty acid having from 4 to 16 carbon numbers to the fat and/or oil for heat cooking to produce an alkali metal content in the fat and/or oil composition for heat cooking of from 0.1 to 5.0 mass ppm. A typical fat and/or oil for heat cooking as described above may be used as the fat and/or oil for heat cooking, and a frying fat and/or oil with which a fry operation is performed may also be used. Any alkali metal soap described above may be used as the alkali metal soap of a saturated fatty acid having from 4 to 16 carbon numbers. As a way to add the alkali metal soap of a saturated fatty acid having from 4 to 16 carbon numbers to the fat and/or oil for heat cooking, the way described above with respect to the step of adding the alkali metal soap of a saturated fatty acid having from 4 to 16 carbon numbers to produce an alkali metal content in a fat and/or oil composition for heat cooking of from 0.1 to 5.0 mass ppm, which is comprised in the method for preparing the fat and/or oil composition according to the present disclosure, may be used.

### EXAMPLES

Hereinafter, the present disclosure will be described in detail based on Examples. However, the present disclosure is not limited to these Examples.

Sample oils of Examples and Comparative Examples were prepared according to the formulae shown in Tables 1 and 2 and subjected to heating tests. Subsequently, the acid value, the polymerized triglycerides content, and the color value of each sample were evaluated. Procedures of preparing the sample oils, procedures of heating tests, an evaluation method, and results are described in detail below.

### <Preparation of Sample Oils>

As the fat and/or oil, Nisshin canola oil (manufactured by Nisshin Oillio Group, Ltd.) was used.

As the alkali metal soaps of a saturated fatty acid having from 4 to 16 carbon numbers, sodium caprylate (C8:0, “sodium n-octoate” manufactured by Tokyo Chemical Industry Co., Ltd.), sodium laurate (C12:0, manufactured by Tokyo Chemical Industry Co., Ltd.), and sodium palmitate (C16:0, manufactured by Tokyo Chemical Industry Co., Ltd.) were used.

As the alkali metal soaps contained in Comparative Examples, sodium stearate (C18:0, manufactured by Tokyo Chemical Industry Co., Ltd.) and sodium oleate (C18:1, manufactured by Tokyo Chemical Industry Co., Ltd.) were used.

The sample oil of Comparative Example 1 consisted of only the fat and/or oil and did not contain an alkali metal soap.

Regarding the sample oil of each of Examples 1 to 3, an alkali metal soap of a saturated fatty acid having from 4 to 16 carbon numbers was mixed to the fat and/or oil uniformly, and the alkali metal (sodium) content was measured by an atomic absorption spectrophotometer (“Z2310” manufactured by Hitachi High-Technologies Corporation). The alkali metal content in each sample oil was 2 mass ppm.

Regarding the sample oils of Comparative Examples 2 and 3, an alkali metal soap of a saturated fatty acid having 18 carbon numbers (sodium stearate) or an alkali metal soap of an unsaturated fatty acid having 18 carbon numbers (sodium oleate) was mixed to the fat and/or oil uniformly, and the alkali metal (sodium) content was measured by an atomic absorption spectrophotometer (“Z2310” manufactured by Hitachi High-Technologies Corporation). The alkali metal content in each sample oil was 2 mass ppm.

The sample oil of Comparative Example 4 contained only the fat and/or oil and did not contain an alkali metal soap.

Regarding each sample oil of Examples 4 and 5 and Comparative Example 5, an alkali metal soap of a saturated fatty acid having 12 carbon numbers (sodium laurate) was mixed to the fat and/or oil uniformly, and the alkali metal (sodium) content was measured by an atomic absorption spectrophotometer (“Z2310” manufactured by Hitachi High-Technologies Corporation). The alkali metal contents of the sample oils were 0.3 mass ppm in Example 4, 3.1 mass ppm in Example 5, and 6.1 mass ppm in Comparative Example 5.

### <Heating Test 1>

In the heating test 1, 10.0 g of each of the prepared sample oils (Comparative Examples 1 to 3 and Examples 1 to 3) was poured into a test tube having a diameter of 20 mm and a length of 120 mm. The test tubes into which the sample oil was poured were heated by a block heater for 32 hours at 185° C. Table 1 shows results of the acid values, the polymerized triglycerides contents, and the color values of the heated sample oils.

### <Heating Test 2>

In the heating test 2, 10.0 g of each of the prepared sample oils (Comparative Examples 4 and 5 and Examples 4 and 5) was poured into a test tube having a diameter of 30 mm and a length of 120 mm. The test tubes into which the sample oil was poured were heated by a block heater for 24 hours at 185° C. Table 2 shows results of the acid values, the polymerized triglycerides contents, and the color values of the heated sample oils.

### <Acid Value>

The acid value of each of the heated sample oils was measured according to “2.3.1-2013 Acid Value”, Standard Methods for the Analysis of Fats, Oils and Related Materials (defined by the Japan Oil Chemists' Society). An acid value indicates the amount of free fatty acid contained in a fat and/or oil and is represented by mg of potassium hydroxide required for neutralizing 1 g of the sample oil. The smaller the acid value is, the less the amount of free fatty acid is, and the more an increase in acid value is suppressed.

In addition, rates of changes (%) in acid value were calculated, with the acid value of Comparative Example 1 being regarded as a reference value in Table 1, and with the acid value of Comparative Example 4 being regarded as a reference value in Table 2. The rates of changes are shown in brackets. A minus value indicates a decrease compared with the acid value of Comparative Example 1 or Comparative Example 4.

### <Polymerized Triglycerides Content>

The polymerized triglycerides content in each of the heated sample oils was measured according to “2.5.7-2013 Polymerized Triglycerides (by Gel Permeation Chromatography)”, Standard Methods for the Analysis of Fats, Oils and Related Materials (defined by the Japan Oil Chemists' Society). The smaller the value is, the less Polymerized Triglycerides are generated.

In addition, rates of changes (%) in polymerized triglycerides content were calculated, with the polymerized triglycerides content of Comparative Example 1 being regarded as a reference value in Table 1, and with the polymerized triglycerides content of Comparative Example 4 being regarded as a reference value in Table 2. The rates of changes are shown in brackets. A minus value indicates a decrease compared with the polymerized triglycerides content of Comparative Example 1 or Comparative Example 4.

### <Color Value>

The degree of coloring of each of the heated sample oils was measured by a Lovibond colorimeter (Lovibond PFX995, manufactured by the Tintometer Limited) employing a ½ inch cell to scale yellowness (Y) and redness (R). From the measured chromaticity, color values (Y+10R) reflecting the degree of coloring by appearance were calculated and evaluated. The smaller the color value is, the less the degree of coloring by appearance is, and the more the coloring is suppressed.

In addition, rates of changes (%) in color value were calculated, with the color value of Comparative Example 1 being regarded as a reference value in Table 1, and with the color value of Comparative Example 4 being regarded as a reference value in Table 2. The rates of changes are shown in brackets.

TABLE 1

| | | Alkali | | | |
|---|---|---|---|---|---|
| | | metal | | Polymerized | |
| | | content | | triglycerides | |
| | | (mass | Acid value | content | Color value |
| | Alkali metal soap | ppm) | (rate of change) | (rate of change) | (rate of change) |
| Comparative | — | 0 | 1.24 (0%) | 32.9 (0%) | 11.7 (0%) |
| Example 1 | | | | | |
| Example 1 | Sodium caprylate | 2.0 | 0.95 (−23.4%) | 23.8 (−27.7%) | 14.7 (25.6%) |
| Example 2 | Sodium laurate | 2.0 | 0.95 (−23.4%) | 24.1 (−26.7%) | 14.7(25.6%) |
| Example 3 | Sodium palmitate | 2.0 | 0.96 (−22.5%) | 24.1 (−26.7%) | 15.1 (29.1%) |
| Comparative | Sodium stearate | 2.0 | 0.96 (−22.5%) | 24.2 (−26.4%) | 17.6 (50.4%) |
| Example 2 | | | | | |
| Comparative | Sodium oleate | 2.0 | 0.95 (−23.4%) | 23.2 (−29.5%) | 16.9 (44.4%) |
| Example 3 | | | | | |

In the sample oils of Examples, an increase in acid value and generation of polymerized triglycerides were significantly decreased, progress of coloring was suppressed to a minimal degree compared with Comparative Example 1, and thus, all the indexs of deterioration were suppressed in a balanced manner.

Regarding Comparative Example 2, which contained the alkali metal soap of a saturated fatty acid having 18 carbon numbers (sodium stearate), and Comparative Example 3, which contained the alkali metal soap of an unsaturated fatty acid having 18 carbon numbers (sodium oleate), although an increase in acid value and generation of polymerized triglycerides were decreased to the same extent as Examples, coloring was significantly promoted compared with Examples.

TABLE 2

| | | Alkali | | | |
|---|---|---|---|---|---|
| | | metal | | Polymerized | |
| | | content | | triglycerides | |
| | | (mass | Acid value | content | Color value |
| | Alkali metal soap | ppm) | (rate of change) | (rate of change) | (rate of change) |
| Comparative | — | 0 | 1.10 (0%) | 26.1 (0%) | 7.3 (0%) |
| Example 4 | | | | | |
| Example 4 | Sodium laurate | 0.3 | 1.02 (−7.3%) | 25.5 (−2.3%) | 7.5 (2.7%) |
| Example 5 | Sodium laurate | 3.1 | 0.63 (−43.6%) | 19.2 (−26.4%) | 8.8 (20.5%) |
| Comparative | Sodium laurate | 6.1 | 0.77 (−30.0%) | 17.8 (−31.8%) | 15.6 (133.7%) |
| Example 5 | | | | | |

Regarding the sample oils of Examples, an increase in acid value and generation of polymerized triglycerides were significantly decreased, progress of coloring was suppressed to a minimal degree compared with Comparative Example 4, and thus, all the indexs of deterioration were suppressed in a balanced manner.

Regarding Comparative Example 5, which contained a greater alkali metal content than the range defined in the present disclosure, although an increase in acid value and generation of polymerized triglycerides were decreased to the same extent as Examples, coloring was significantly promoted compared with Examples.

### INDUSTRIAL APPLICABILITY

A fat and/or oil composition for heat cooking according to the present disclosure may be used in the field of food manufacturing preferably as a frying oil employed in manufacture of fried foods. A fat and/or oil composition for heat cooking according to the present disclosure may also be used in manufacture of any other foods requiring a fat and/or oil for heat cooking.

1. A fat and/or oil composition for heat cooking, comprising a fat and/or oil, and an alkali metal soap of a saturated fatty acid having from 4 to 16 carbon numbers, wherein an alkali metal content in the fat and/or oil composition for heat cooking is from 0.1 to 5.0 mass ppm.

2. The fat and/or oil composition for heat cooking according to claim 1, wherein the alkali metal soap comprises a sodium soap.

3. A method of preparing a fat and/or oil composition for heat cooking, comprising the steps of:
refining a fat and/or oil, and thereafter
adding an alkali metal soap of a saturated fatty acid having from 4 to 16 carbon numbers to the refined fat and/or oil to produce an alkali metal content in the fat and/or oil composition for heat cooking of from 0.1 to 5.0 mass ppm.

4. The method of preparing a fat and/or oil composition for heat cooking according to claim 3, wherein the alkali metal soap comprises a sodium soap.

5. A method of preventing deterioration of a fat and/or oil for heat cooking caused by heating, comprising the step of adding an alkali metal soap of a saturated fatty acid having from 4 to 16 carbon numbers to the fat and/or oil for heat cooking to produce an alkali metal content in the fat and/or oil composition for heat cooking of from 0.1 to 5.0 mass ppm.

6. The method of preventing deterioration of a fat and/or oil for heat cooking caused by heating according to claim 5, wherein the alkali metal soap comprises a sodium soap.
